(19) United States
(12) Patent Application Publication
(10) Pub. No.: US 2006/0089911 A1
(43) Pub. Date: Apr. 27, 2006

(54) Method for transferring purchased and downloaded content to a new information handling system by consuming additional content rights

(76) Inventors: Shree A Dandekar, Round Rock, TX (US); Shannon Christopher Boesch, Austin, TX (US)

Correspondence Address: HAMILTON & TERRILE, LLP, P.O. BOX 203518, AUSTIN, TX, 78720, US

(21) Appl. No.: 10/974,488

(22) Filed: Oct. 26, 2004

(51) Int. Cl. G06F 17/60

(52) U.S. Cl. 705/51

(57) ABSTRACT

A method for loading previously purchased content onto a new information handling system which includes determining whether a user has available transfer options based upon a unique identifier, and loading the previously purchased content onto the new information handling system if the user has available transfer options.

### BACKGROUND OF THE INVENTION

1. Field of the Invention

The present invention relates to information handling systems, and more particularly to transferring purchased and downloaded music to a new information handling system by consuming additional content rights.

2. Description of the Related Services

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

One aspect of information handling system relates to the marketing and supply of information handling systems such as computer systems along with peripherals. Known information handling system suppliers such as Dell, Inc. provide peripherals via the same channel as their computer systems. However, the information handling system peripheral market continues to grow in complexity. It is known for information handling system suppliers to bundle existing software (e.g., music, photography, security, etc.) solutions with peripherals.

One aspect of ordering information handling systems relates to up-selling. Up selling relates to selling additional products or services relating to a particular product or service. For example, when a customer orders a music player such as an MP3 player, from a supplier, an up sell might be providing the user with a particular number of music downloads for use with the music player. It is known to allow a customer when ordering an information handling system to order peripherals and up sells at the point of sale (POS) of the computer system and peripheral. Alternately, a customer may solely purchase a peripheral without purchasing a computer system. Additionally, some customers may not wish to purchase any additional products or services when purchasing a new information handling system.

Additionally, a customer might only purchase a license to download a number of instantiations of content (e.g., a license to download a certain number of music downloads). For example, the supplier might provide an introductory offer allowing for a predetermined number of downloads for on demand music services. Using the music service, a customer can quickly purchase currently playing tracks and add them to an existing music library for a relatively low price per song. Once downloaded onto the customer's computer systems, the tracks can then be copied to a portable devices (such as an MP3 music player) or burned onto a non-volatile device such as a CD so that the customer can access the content while away form the computer system. The right to download a particular piece of content often includes a license to copy to content a predetermined number of times. Accordingly, the downloaded copy of the content is a first copy, the copy to the music player is a second copy and the copy to a CD is a third copy. Once the content has been copied the predetermined number of times, a customer would have to purchase a new license to further copy the content.

Issues relating to the automated download process include when a customer purchases another or newer computer system from the information handling system supplier or a computer system provided by another information handling system supplier, the customer might want to transfer the content from the original computer system (i.e., the system to which the content was originally downloaded) to another computer system without violating the copyright protection. Additionally, a customer may have a supplier peripheral that is used with a non-supplier computer system. If the customer then decides to purchase a supplier computer system and wants to transfer the content from the supplier peripheral to the newly purchased supplier computer system.

### SUMMARY OF THE INVENTION

In accordance with the present invention, a method for transferring purchased and downloaded content to a new information handling system by consuming content rights is set forth. The method capitalizes on content licensing terms which provide multiple permitted copies of content within a certain content download license.

More specifically, the supplier leverages a customer's existing content rights to transfer content to new hardware easily and efficiently. The hardware includes new systems or peripherals such as memory devices, media appliances media players, etc. The content transfer and digital rights management process may occur within the supplier manufacturing facility or at a customer premises.

In one scenario, a customer purchases another supplier or non supplier computer system and wants to transfer the content onto the new system from an original system or from a customer specific online repository. In this case, the customer logs into a customer specific music service from the new system. Based on the user's registration information, the service or software provide will then provide the user with the option to download the tracts from the original system to the new system. Before the service performs the download, the service ensures that the user has not already exceeded the maximum quota of system to which the content may be copied. Also, if the user does not remember the user registration details, the service provider will query the user regarding a unique identifier from the original system.

In another scenario, a customer purchases a new computer system and wishes to transfer content from a supplier peripheral to the new system. Because licenses limit transferring tracks from a peripheral device to a system, substantially all tracks to be transferred should reside in the original system. The customer logs onto a customer specific music service from the new system. Based on the user's registration information, the service or software provide provides the user with the option of downloading tracks from the original system to the new system. Before the service allows the download, the service ensures that the user has not already exceeded the maximum quota of systems to which the content may be copied. Also, if the user does not remember the user registration details, the services provider ensure the validity of the customer by accessing the unique identifier from the supplier peripheral device.

In one embodiment, the invention relates to a method for loading previously purchased content onto a new information handling system which includes determining whether a user has available transfer options based upon a unique identifier, and loading the previously purchased content onto the new information handling system if the user has available transfer options.

In another embodiment, the invention relates to an apparatus for loading previously purchased content onto a new information handling system which includes means for determining whether a user has available transfer options based upon a unique identifier, and means for loading the previously purchased content onto the new information handling system if the user has available transfer options.

In another embodiment, the invention relates to a system for loading previously purchased content onto a new information handling system which includes an available options determining module and a loading module. The available options determining module determines whether a user has available transfer options based upon a unique identifier. The loading module loads the previously purchased content onto the new information handling system if the user has available transfer options.

In another embodiment, the invention relates to a method for loading previously purchased content onto a new information handling system which includes determining whether a user has available transfer options based upon a unique identifier, loading the previously purchased content onto the new information handling system if the user has available transfer options, determining whether the unique identifier has an associated user account, loading the previously purchased content onto the new information handling system when the associated user account is present, and determining whether the unique identifier corresponds to a valid system.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of a customer accessing a system configuration store.

FIG. 2 shows a system block diagram of an information handling system.

FIG. 3 shows a schematic block diagram of the system configuration store.

FIG. 4 shows a flow chart of a method for transferring purchased and downloaded content from an original system to a new system.

FIG. 5 shows a flow chart of a method for transferring purchased and downloaded content from a peripheral to a new system.

FIG. 6 shows a flow diagram of the configuration of an information handling system to include the customization features.

### DETAILED DESCRIPTION

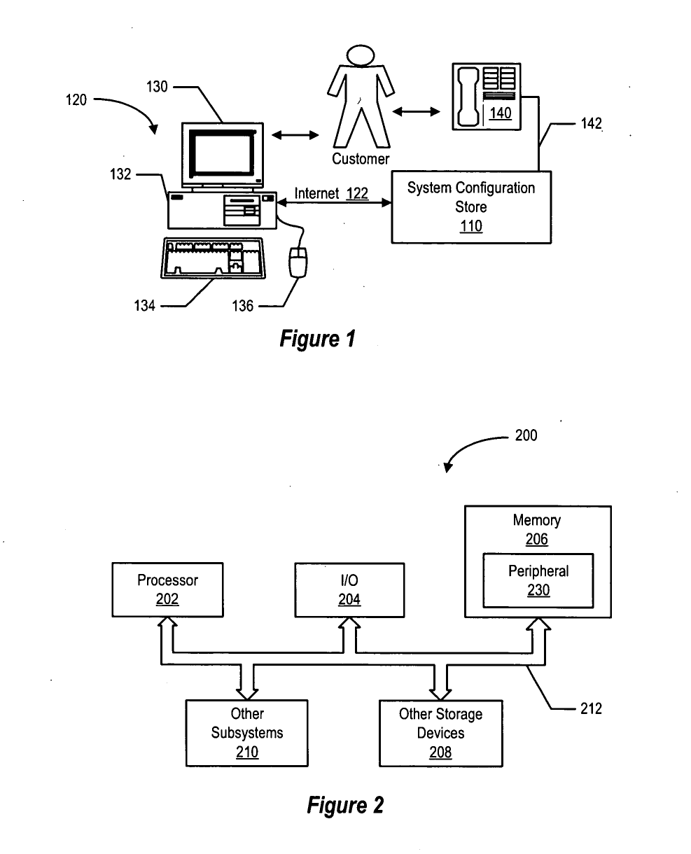

Referring to FIG. 1, a customer can access a system configuration store 110 using any suitable computer equipment 120, via the Internet 122. The computer equipment 120 may include a display 130, computer system 132, keyboard 134, and pointing device 136. Display 130 is used for displaying the various pages of the on-line store while a customer is using the on-line store. Alternately, a customer can access the system configuration store 110 via a telephone 140 which is coupled to the system configuration store via a telephone network 142. In the case of a telephone access to the system configuration store, the customer speaks with a sales representative who obtains the configuration information from the customer and in turn enters the information into the system configuration store 110 to configure a system. The system configuration store 110 also enables a customer to purchase peripherals either with a system or independent of a system. The system configuration store 110 also enables a customer to purchase content that may then be downloaded onto the computer system 132 or other type of information handling system.

Referring to FIG. 2, a system block diagram of an information handling system 200 is shown having features configured in accordance with the system configuration store 110. The information handling system 200 includes a processor 202, input/output (I/O) devices 204, such as a display, a keyboard, a mouse, and associated controllers, memory 206 including volatile memory such as random access memory (RAM) and non-volatile memory such as a hard disk and drive, and other storage devices 208, such as a floppy disk drive, a CD ROM drive and other memory devices, and various other subsystems 210, all interconnected via one or more buses 212.

The information handling system may include peripheral related software 230 stored within the memory 206.

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

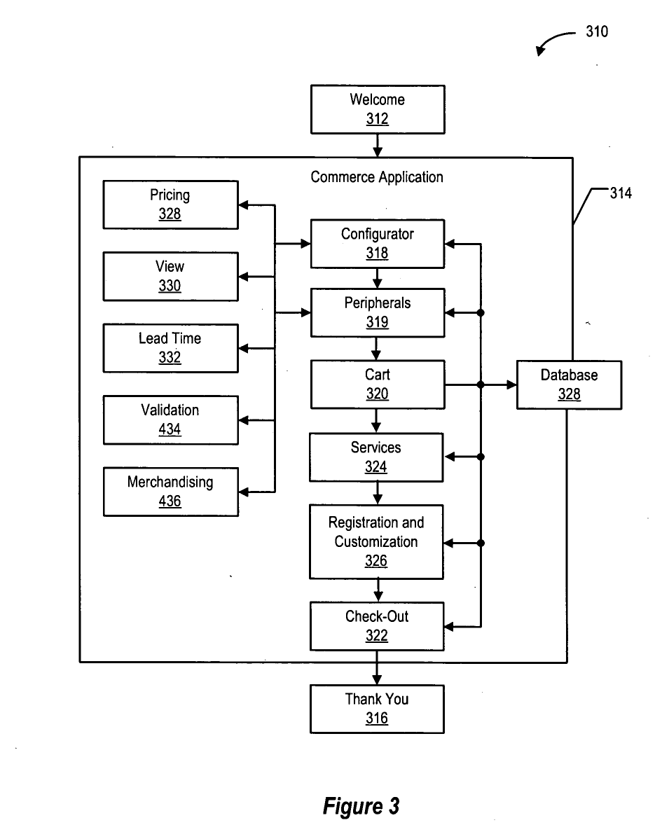

Referring to FIG. 3, an on-line store is a component of an Internet website to which a customer may go to configure a particular information handling system, for example, according to desired options of the customer. An on-line store is one example of a system configuration store 110. The on-line store is typically a subset of a larger Internet website. At the on-line store, a customer can select one or more products in which the customer is interested. Upon selection of a particular product, the on-line store presents the customer with the ability to go to the product information for the particular product, customize the product, price the customized product, purchase the product, and other actions as discussed herein. While shopping happens in the website (i.e., selection of a particular kind of system by a customer), when the customer is ready to purchase a customized system, the customer is then directed to that part of the website which the on-line store application controls.

An on-line store 310 for use in generating customer configured information handling systems, e.g., customer configured computer systems, is shown. The on-line store 310 includes a welcome or introductory module 312, a commerce application module 314, and a thank you module 316. The on-line store 310 includes an on-line store user interface which enables the system configuration, pricing, and ordering of an information handling system via the Internet. The commerce application 314 includes a configurator 318, a peripheral module 319, a shopping cart 320, a checkout module 322, a services activation module 324, a registration and customization module 326 and database 328. The database 328 provides information to the configurator 318, peripherals module 319, shopping cart 320, checkout module 322, services module 324 and registration and customization module 326. The configurator 318 (and the peripherals module 319) includes a pricing module 328, a view module 330, a lead time warning module 332, a validation (or compatibility) warning module 334, and a merchandising module 336. The various modules of the configurator 318 are driven by data from the database 328, and thus the configurator 318, shopping cart 320, checkout module 322 and services activation module 324 are all linked to the database 328.

In operation of the on-line store 310, the welcome module 312 presents a welcome page 312, the configurator 318 presents a configurator page, the peripherals module 319 presents a peripherals page, the shopping cart 320 presents a shopping cart page, the checkout module 322 presents a checkout page, the services activation module 324 presents a services page, the registration and customization module 326 provides a registration and cust6mization page and the thank you module 316 presents a thank you page. The welcome page includes a static page and generally resides outside of the commerce application 314. The configurator page, peripherals page, shopping cart page, checkout page, services page and registration and customization page are within the commerce application and use information provided by the database. The checkout includes a payment feature, delivery feature, personal versus business feature, and instructional text features (i.e., how to fill out an on-line form.) The welcome page is typically an introductory page and includes a link into the on-line store 310. The welcome page is typically a static welcome page. Upon completion of configuration of a system, is transferred to a services activation page in which the customer is provided an opportunity to activate various services such as internet service or content services such as music services. After completion of the services activation, the customer is transferred to the registration and customization page. After completion of the registration and customization, the customer is transferred to a checkout page. After completion of the checkout, the customer is transferred to a static thank you page. The thank you page provides a message of gratitude to the customer for having placed the order or for visiting the on-line store.

Aspects of the configurator 318 which interact with database 328 are shown in FIG. 3. In essence, the entire commerce application 314 interacts with the database. The configurator 318, peripherals module 319, shopping cart 320, checkout module 322, services module 324 and registration and customization module are each part of the commerce application 314 and interact with the database 328. For example, with the shopping cart 320, additional merchandising information associated with a particular system which has been configured and placed in the shopping cart by an on-line store customer can be provided.

Also for example, various services may be provided for order by the customer by the services module 324 based upon the type of system or peripherals ordered as well as components that are included within the system ordered. The services module 324 may also present the option of a customer to order content which can be downloaded to a computer system, a peripheral or other type of information handling system. Additionally, by providing the services module within the commerce application 314, the customer continues the experience a similar customer experience and the system provider is able to use the information from the database 328 and to maintain control over the customer contact. By maintaining control over the customer contact the system provider is able to determine what services are activated and to maintain accurate and up to date records of the service activation. The services module 324 includes a proactive point of sale prequalification module. When a purchase is processed via the telephone, then the customer representative interacts with a system similar to configurator 318.

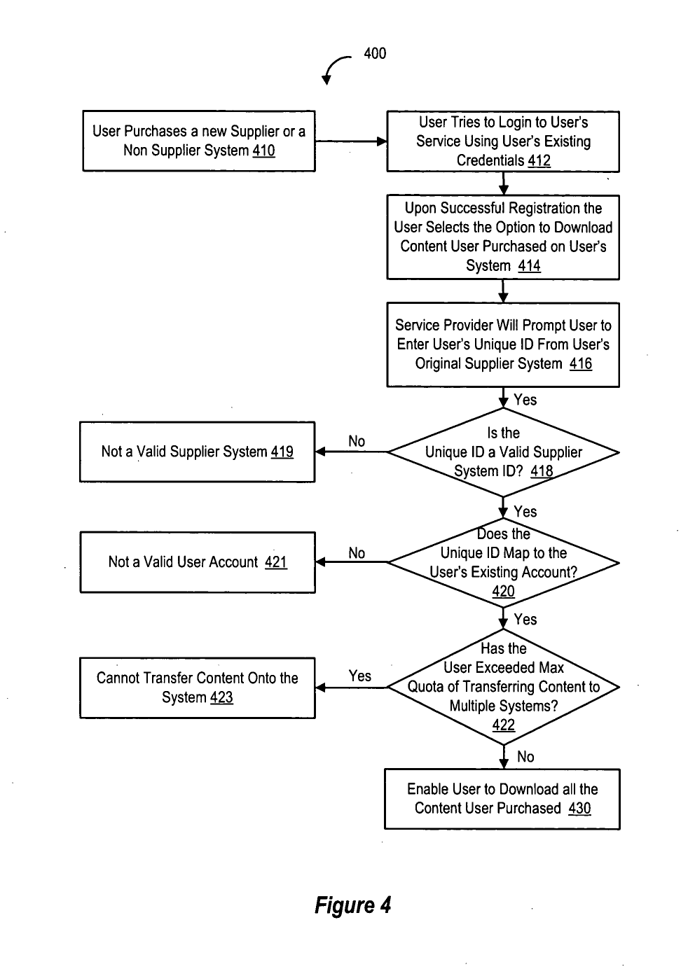

Referring to FIG. 4, a flow chart of a method for transferring purchased and downloaded content from an original system to a new system is shown. This method is used when a customer purchases another supplier or non supplier computer system and wants to transfer the content onto the new system from an original system or from a customer specific online repository. In this case, the customer logs into a customer specific music service from the new system. Based on the user's registration information, the service or software provide will then provide the user with the option to download the tracts from the original system to the new system. Before the service performs the download, the service ensures that the user has not already exceeded the maximum quota of system to which the content may be copied. Also, if the user does not remember the user registration details, the service provider will query the user regarding a unique identifier from the original system.

More specifically, a user purchases a suppler or non supplier system at step 410. The user then attempts to log into the user's services via existing credentials at step 412. Upon a successful registration of the new system, the user may select an option to download all previously purchased content onto the new system at step 414. The service provider prompts the user to provide a unique identifier from the original system at step 416. The unique identifier may be a supplier service tag or some other form of supplier specific information that is stored within the original user computer system. A service tag is an example of an identifier that is both supplier specific and system specific, i.e., the service tag uniquely identifies the system as a particular system to the system supplier.

When the unique identifier is provided at step 416, then the process proceeds to determine whether the unique identifier corresponds to a valid supplier system at step 418. If the unique identifier does not correspond to a valid supplier system, then the method so indicates at step 419. If the unique identifier corresponds to a valid supplier system, then the process proceeds with determining whether the unique identifier maps to an existing account of the user at step 420.

If the unique identifier does not map to an existing account, then the method indicates that the customer does not have a valid user account at step 421. If the unique identifier maps to an existing user account, then the process proceeds with determining whether the user has exceeded a maximum quota of transferring content to multiple systems at step 422.

If the user has exceeded a maximum quota of transferring content, then the method indicates that the customer cannon transfer content at step 423. If the user has not exceeded a maximum quota of transferring content, then the method enables the user to download the previously purchased content onto the new system at step 430.

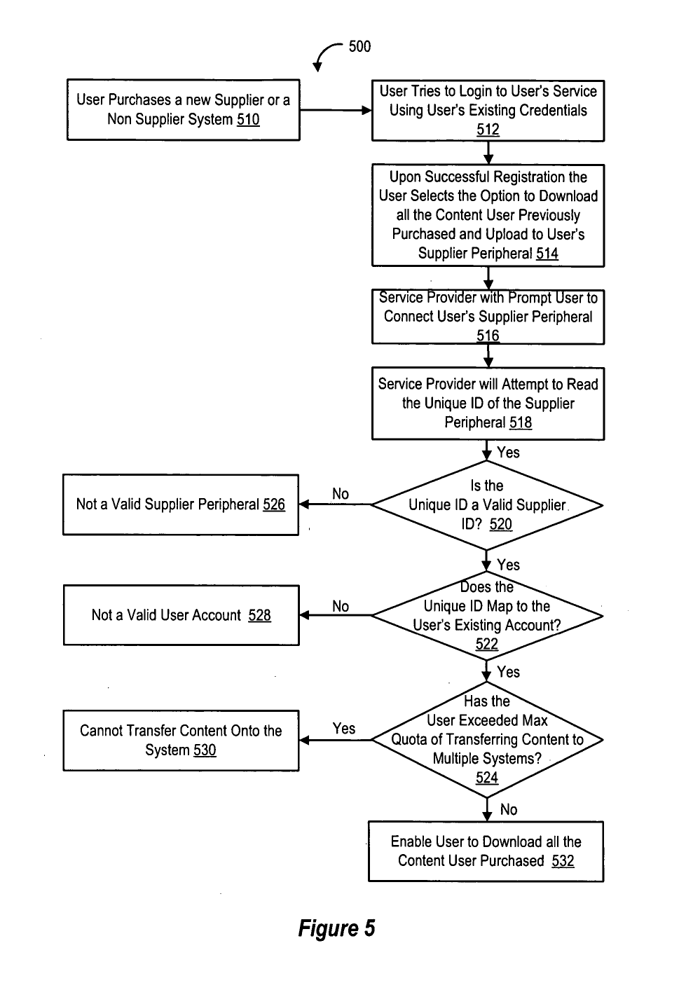

Referring to FIG. 5, a flow chart of a method for transferring purchased and downloaded content from a peripheral to a new system is shown. This method is used when a customer purchases a new computer system and wishes to transfer content from a supplier peripheral to the new system. Because licenses limit transferring tracks from a peripheral device to a system, substantially all tracks to be transferred should reside in the original system. The customer logs onto a customer specific music service from the new system. Based on the user's registration information, the service or software provide provides the user with the option of downloading tracks from the original system to the new system. Before the service allows the download, the service ensures that the user has not already exceeded the maximum quota of systems to which the content may be copied. Also, if the user does not remember the user registration details, the services provider ensure the validity of the customer by accessing the unique identifier from the supplier peripheral device.

More specifically, a user purchases a suppler or non supplier system at step 510. The user then attempts to log into the user's services via existing credentials at step 512. Upon a successful registration of the new system, the user may select an option to download all previously purchased content onto the new system at step 514. The service provider prompts the user to provide a unique identifier from the original supplier peripheral at step 516. The unique identifier may be a supplier service tag or some other form of supplier specific information that is stored within the original user computer system. A service tag is an example of an identifier that is both supplier specific and system specific, i.e., the service tag uniquely identifies the system as a particular system to the system supplier.

When the unique identifier is provided at step 516, then the process proceeds to determine whether the unique identifier corresponds to a valid supplier peripheral at step 518. If the unique identifier does not correspond to a valid supplier peripheral, then the method so indicates at step 519. If the unique identifier corresponds to a valid supplier peripheral, then the process proceeds with determining whether the unique identifier maps to an existing account of the user at step 520.

If the unique identifier does not map to an existing account, then the method indicates that the customer does not have a valid user account at step 521. If the unique identifier maps to an existing user account, then the process proceeds with determining whether the user has exceeded a maximum quota of transferring content to multiple systems at step 522.

If the user has exceeded a maximum quota of transferring content, then the method indicates that the customer cannon transfer content at step 523. If the user has not exceeded a maximum quota of transferring content, then the method enables the user to download the previously purchased content onto the new system at step 530.

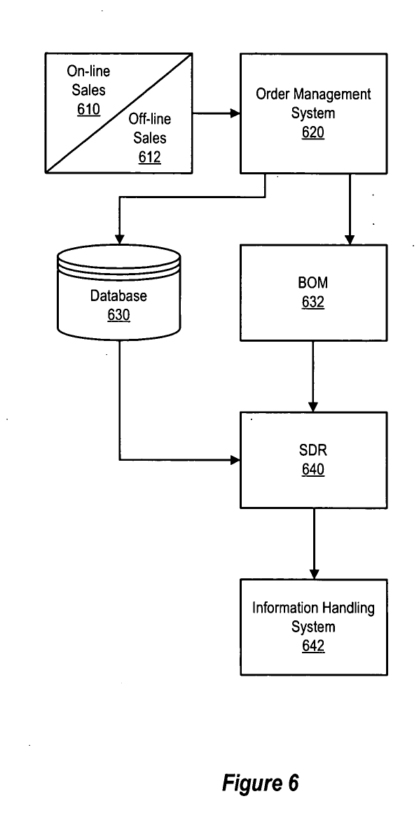

Referring to FIG. 6, when registration or customization information is obtained either via on-line sales 610 or via off-line (e.g., telephone) sales 612, the information is provided to an order management system 620 which interacts with the factory in which the system is manufactured. The order management system 620 stores this information to a database 630 as well as to a Bill of Materials (BOM) 632 which is associated with a particular system being manufactured or peripheral being purchased. It will be appreciated that one or both the database 630 or the BOM 632 may be used to transfer the information from the customer order to a particular information handling system. The information is then stored in a system descriptor record (SDR) which is stored on the memory of the information handling system 642 being manufactured. Certain types of peripherals (e.g., music players) may also be information handling systems on which this information may be stored. Accordingly, the registration or customization information that is obtained from the customer is stored on the system that is manufactured for that customer.

Other Embodiments

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, it will be appreciated that the order in which the customer is presented with the services activation page, the registration and customization page and check out page may vary. E.g., the customer may checkout before accessing the services activation page. Alternately, the services activation module may riot be presented at all.

Also for example, other types of peripherals (e.g., cameras, personal digital assistants (PDAs), personal movie players, etc.) are contemplated. These other types of peripherals may also include downloaded content. For example, a movie player might include downloaded movies.

Also for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for loading previously purchased content onto a new information handling system comprising:
determining whether a user has available transfer options based upon a unique identifier; and,
loading the previously purchased content onto the new information handling system if the user has available transfer options.

2. The method of claim 1 further comprising:
determining whether the unique identifier has an associated user account;
loading the previously purchased content onto the new information handling system when the associated user account is present.

3. The method of claim 1 further comprising:
determining whether the unique identifier corresponds to a valid system.

4. The method of claim 1 wherein:
the new information handling system is one of a computer system and a peripheral device.

5. The method of claim 1 wherein:
the previously purchased content is stored on a supplier information handling system.

6. The method of claim 5 wherein:
the supplier information handling is one of a computer system and a peripheral device.

7. An apparatus for loading previously purchased content onto a new information handling system comprising:
means for determining whether a user has available transfer options based upon a unique identifier; and,
means for loading the previously purchased content onto the new information handling system if the user has available transfer options.

8. The apparatus of claim 7 further comprising:
means for determining whether the unique identifier has an associated user account; and
means for loading the previously purchased content onto the new information handling system when the associated user account is present.

9. The apparatus of claim 7 further comprising:
means for determining whether the unique identifier corresponds to a valid system.

10. The apparatus of claim 7 wherein:
the new information handling system is one of a computer system and a peripheral device.

11. The apparatus of claim 7 wherein:
the previously purchased content is stored on a supplier information handling system.

12. The apparatus of claim 11 wherein:
the supplier information handling is one of a computer system and a peripheral device.

13. A system for loading previously purchased content onto a new information handling system comprising:
an available options determining module, the available options determining module determining whether a user has available transfer options based upon a unique identifier; and,
a loading module, the loading module loading the previously purchased content onto the new information handling system if the user has available transfer options.

14. The system of claim 13 further comprising:
a user account determining module, the user determining module determining whether the unique identifier has an associated user account; and
a user account loading module, the user account loading module loading the previously purchased content onto the new information handling system when the associated user account is present.

15. The system of claim 13 further comprising:
a system determining module, the system determining module determining whether the unique identifier corresponds to a valid system.

16. The system of claim 13 wherein:
the new information handling system is one of a computer system and a peripheral device.

17. The system of claim 13 wherein:
the previously purchased content is stored on a supplier information handling system.

18. The system of claim 17 wherein:
the supplier information handling is one of a computer system and a peripheral device.

19. A method for loading previously purchased content onto a new information handling system comprising:
determining whether a user has available transfer options based upon a unique identifier;
loading the previously purchased content onto the new information handling system if the user has available transfer options;
determining whether the unique identifier has an associated user account; loading the previously purchased content onto the new information handling system when the associated user account is present; and,
determining whether the unique identifier corresponds to a valid system.

20. The method of claim 19 wherein:
the new information handling system is one of a computer system and a peripheral device.

21. The method of claim 19 wherein:
the previously purchased content is stored on a supplier information handling system.

22. The method of claim 21 wherein:
the supplier information handling is one of a computer system and a peripheral device.
